(19) United States
(12) Patent Application Publication
(10) Pub. No.: US 2015/0050128 A1
(43) Pub. Date: Feb. 19, 2015

(54) COMPACT MULTI-STAGE TURBO PUMP

(71) Applicant: JAGUAR LAND ROVER LIMITED, Warwickshire (GB)

(72) Inventor: Olivier Roques, Coventry (GB)

(21) Appl. No.: 14/384,166

(22) PCT Filed: Mar. 8, 2013
(86) PCT No.: PCT/EP2013/054736

§ 371 Date: Sep. 10, 2014

(30) Foreign Application Priority Data
Mar. 12, 2012 (GB) 1204322.0

(51) Int. Cl. F02B 37/14; F04D 27/00

(52) U.S. Cl. CPC F02B 37/14; F04D 27/005
USPC 415/145

(57) ABSTRACT

A turbo pump has a common axis of rotation for a plurality of compressor and turbine wheels. One or more of the turbine and compressor wheels defines a gas passage axially therethrough, said gas passage being associated with another of the turbine and compressor wheels. The arrangement provides a compact multi-stage turbocharger.

### FIELD

This invention relates to a multi-stage turbo pump, in particular a multi-stage turbocharger for an internal combustion engine. Aspects of the invention relate to a pump, to an engine and to a vehicle.

### BACKGROUND

Exhaust driven turbochargers have been used for many years to improve the power and efficiency of internal combustion piston engines, particularly in vehicles. A simple single stage turbocharger comprises an exhaust driven turbine which directly drives a co-axial compressor of inlet gas, thus allowing a greater volumetric charge in each cylinder than would otherwise be the case.

Ideally the exhaust driven turbine would work effectively at all engine speeds and exhaust gas flows, but generally speaking a turbine which is efficient at high engine speeds is somewhat ineffective at low engine speeds (low exhaust gas flow), resulting in the undesirable phenomenon of turbo lag.

Likewise a turbine which is efficient at low engine speeds would likely be limited at high engine speeds, resulting in a corresponding lack of engine power. The efficiency of the turbocharger also decreases at high engine speeds, as a bypass valve (wastegate) must be opened to divert the exhaust gas flow that cannot be handled by the turbine.

As a result two-stage turbochargers have been proposed which comprise a low pressure turbine and high pressure turbine. These turbines may operate sequentially or partly or wholly in unison to deliver efficient charge compression substantially throughout the engine speed range.

One consequence of two-stage turbocharging is the necessity for separate gas pathways to and from each turbine stage and the requirement for flow valves and control apparatus to ensure that each turbine stage operates in the appropriate engine speed range.

Two compressor stages may also be provided to give better charge compression at low and high air flow rates, and of necessity separate gas pathways, flow valves and control apparatus must be provided.

The consequence of the additional gas pathways and control valves is that the turbocharger becomes physically large and heavy, and correspondingly difficult to fit within the confined space adjacent an engine exhaust manifold. This problem is exacerbated by downsized engines and exhaust manifolds. A further consequence is that significant heat could be radiated on the turbine side from these passageways, so that light-off of an exhaust catalyst may be delayed, which is not conducive to meeting increasingly strict emissions legislation.

Turbochargers may have three or more stages, but inevitably the overall space required, including gas pathways, is increased still further.

Another means of improving turbocharger performance throughout the engine speed range is to provide variable geometry blades adapted to the throughput of gas. Such variable geometry systems are effective, but may require yet more control and actuation devices.

### SUMMARY OF THE INVENTION

It is against this background that the present invention has been conceived. Embodiments of the invention may provide a turbo pump, particularly a multi-stage exhaust driven turbo pump, which is significantly more compact. Other aims and advantages of the invention will become apparent from the following description, claims and drawings.

By multi-stage turbo pump we mean a turbo pump having a plurality of turbine and/or compressor wheels which are arranged so as to increase the engine speed range over which the turbo pump can perform effectively. The stages are generally incorporated in a turbocharger within a common assembly immediately downstream of the or each exhaust manifold, and include valves to control the operation of each stage and the overlap between successive stages. Typically two stages are provided consisting of paired turbine and compressor wheels of small diameter for low gas flow rates, and large diameters for high gas flow rates.

According to one aspect of the present invention, there is provided a turbo pump having a plurality of compressor wheels and a plurality of turbine wheels rotatable in a housing about a common axis, one of the compressor or turbine wheels having an axial throughflow passage for supplying fluid to another of the compressor or turbine wheels. Thus an upstream compressor may provide an inlet through path to a downstream compressor. An upstream turbine may exhaust through a downstream turbine.

In an embodiment the flow of gas to a compressor or turbine wheel may both drive that wheel, and pass through that wheel. Thus a single supply passage may be provided to the upstream side of the apertured compressor wheel, and from the downstream side of the apertured turbine wheel. On the compressor side, the gas passing through the compressor wheel of one stage is associated with a downstream compressor wheel of another stage. On the turbine side, the gas passing through the turbine wheel of one stage is associated with an upstream turbine wheel of another stage.

In one embodiment the turbo pump is a multi-stage turbocharger in which plural pairs of compressor and turbine wheels operate in conjunction to provide effective charge compression substantially throughout an engine speed range.

In one embodiment of a turbocharger, a compressor wheel and a turbine wheel permit gas to pass axially therethrough; the compressor wheel and the turbine wheel may be associated with the same stage of the compressor.

In one embodiment the gas flow passage of the or each apertured wheel is substantially co-axial about the axis of rotation, and may be of constant cross-section.

The or each apertured wheel may include vanes, which may extend along the through passage. The vanes may be axially straight or shaped to influence gas flow. For example such vanes may be arcuate in a compressor wheel so as to generate a pre-whirl suitable for the downstream compressor wheel. On the turbine side the vanes may be used to recover some of the exhaust energy or to improve overall efficiency.

The vanes may further define a means of connecting the blade elements of the or each apertured wheel with the rotatable member connecting the compressor and turbine sides.

In one embodiment the or each apertured wheel is of a comparatively larger diameter and outermost along the axis of rotation.

In one embodiment a two-stage turbocharger is provided, having apertured outermost turbine and compressor wheels. This arrangement allows a single inlet tract to directly supply the two compressor wheels, and a single exhaust tract to be fed directly from the two turbine wheels.

A stator may be provided between adjacent compressor wheels and or between adjacent turbine wheels. The or each stator includes axial vanes which act to realign flow to better suit a downstream wheel, and may be of conventional design.

In an embodiment of the invention an inner pair of turbine and compressor wheels is connected by a tubular shaft rotatable relative to a spindle connecting an outer pair of turbine and compressor wheels, the spindle being supported for rotation in the shaft, and the shaft being supported for rotation in a turbocharger housing.

It may be that one of the compressor wheels is mounted back to back with another of the compressor wheels. It may be that one of the turbine wheels is mounted back to back with another of the turbine wheels. In either case, one of the turbine wheels or compressor wheels which are arranged back to back may still comprise an axial throughflow as described above. In one embodiment of the invention, both compressor and turbine wheels could be mounted back to back.

The housing may be partly or fully coupled with another external charge air device (i.e. a turbo charger or turbo pump). It may be that said housing has at least one gas or exhaust inlet or outlet which is connected to at least one of another charge air device, or an intercooler device, or a manifold device.

Within the scope of this application it is expressly intended that the various aspects, embodiments, examples and alternatives, and in particular the individual features thereof, set out in the preceding paragraphs, in the claims and/or in the following description and drawings, may be taken independently or in any combination. For example features described in connection with one embodiment are applicable to all embodiments, unless such features are incompatible.

### BRIEF DESCRIPTION OF DRAWINGS

Embodiments of the present invention will now be described, by way of example only, with reference to the accompanying drawings, in which:

FIGS. 1-3 illustrate schematically the operation of a conventional two-stage turbocharger;

FIG. 4 illustrates graphically the performance characteristic of a two-stage turbocharger;

FIG. 5 illustrates in cross-section a schematic two-stage turbocharger according to an embodiment of the invention;

FIGS. 6-8 illustrate different flow paths of a two-stage turbocharger according to an embodiment of the invention; and

FIGS. 9-11 illustrate an alternative arrangement of flow paths of a two-stage turbocharger according to an embodiment of the invention;

### DETAILED DESCRIPTION

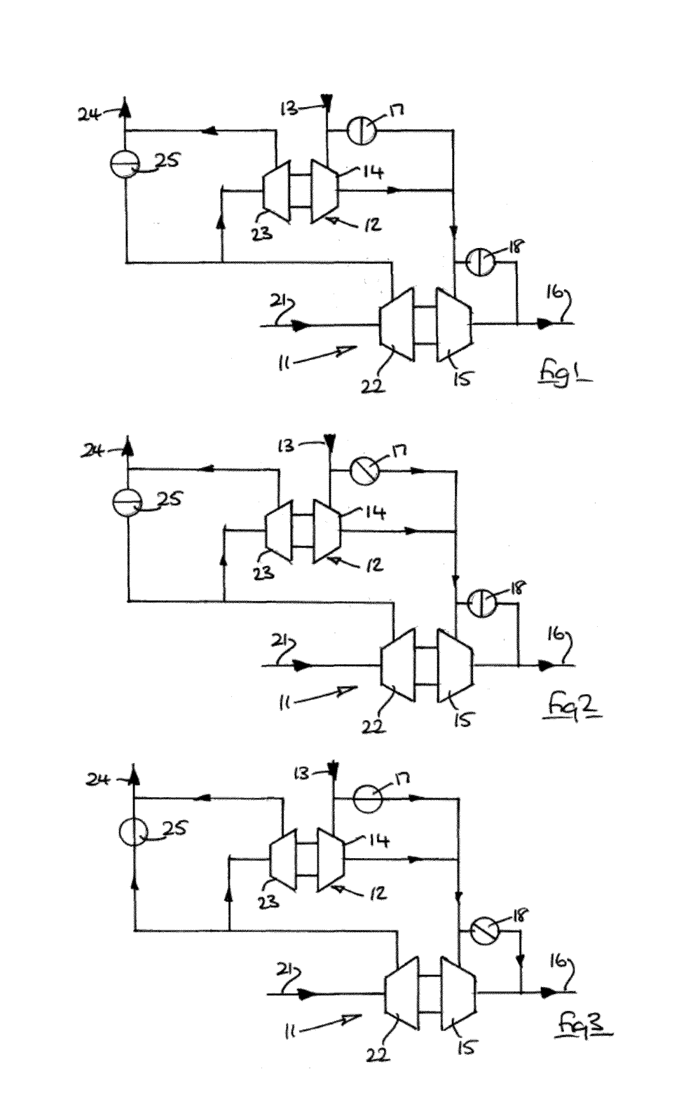

FIGS. 1-3 illustrate a conventional two-stage turbocharger arrangement having a larger diameter turbine/compressor 11, a small diameter turbine/compressor 12 and an example of an arrangement of passageways and valves, which will now be described.

FIG. 1 illustrates lower engine speed operation, in the range 1000-3000 rpm. Exhaust flow from an engine exhaust manifold 13 passes through the small turbine 14, and then via the large turbine 15 to the exhaust tract 16. Bypass valves 17, 18 are closed. In this engine speed range, the small turbine 14 is effective whereas the large turbine 15 is somewhat ineffective.

On the compressor side, gas from the inlet tract 21 passes sequentially through the large compressor 22 and small compressor 23 to the engine inlet manifold 24. A relief valve 25 is closed. In this engine speed range, gas compression is mainly generated by the small compressor 23 (which is driven by the small turbine 14).

FIG. 2 illustrates operation in the mid-engine speed range of 3000-4000 rpm. Exhaust gas flows in this speed range cause the large turbine 15 to make a contribution, and to avoid over-speeding of the small turbine 14, the bypass valve 17 begins to open. On the compressor side the large compressor begins to make a contribution to gas compression as the small compressor approaches maximum output. Both turbines and compressors make a contribution to charge compression.

FIG. 3 illustrates operation in the higher speed range of 4000-6000 rpm. The bypass valve 17 is fully open to avoid over-speeding of the small turbine 14, and the bypass valve 18 also begins to open as the large turbine 15 approaches maximum speed.

On the compressor side, the relief valve 25 opens to bypass the small compressor 23, so that most of the charge compression is achieved by the large compressor 22 (driven by the large turbine).

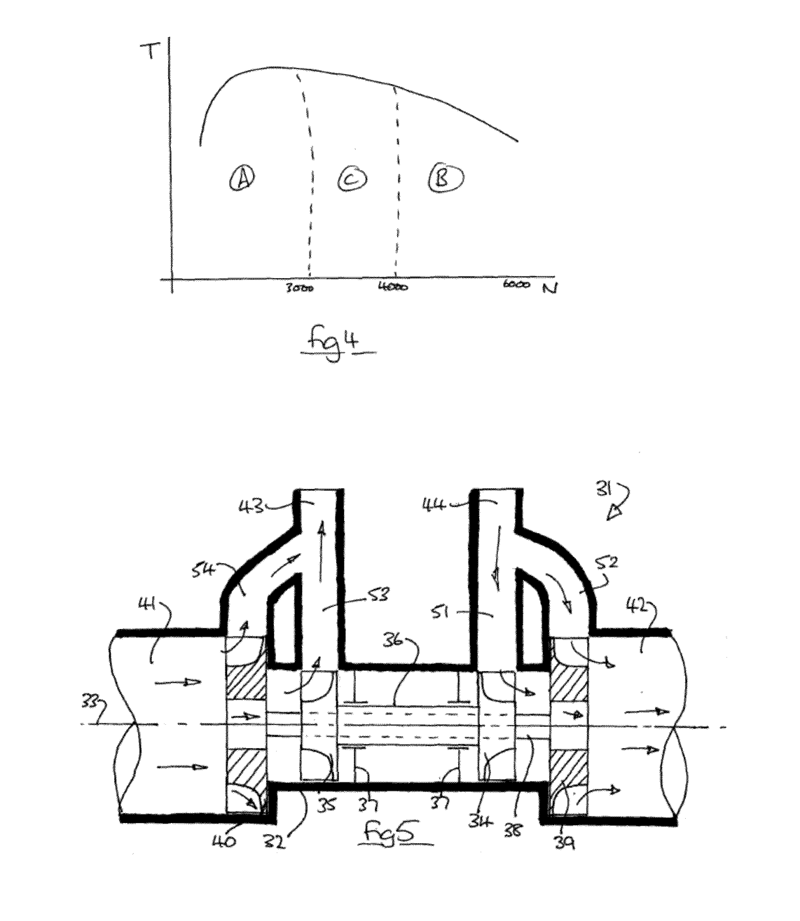

FIG. 4 illustrates a typical performance characteristic for the two-stage turbocharger of FIGS. 1-3, and in which A represents a main contribution from the small turbocharger 11, B represents a main contribution from the large turbocharger 12, and C represents the overlap controlled by the valves 17, 18, 25.

The speed ranges quoted in this example are illustrative and would differ depending for example on the kind of fuel used, but they generally indicate how a two-stage turbocharger can provide effective charge compression throughout a range of engine speeds. Opening and closing of the valves 17, 18, 25 is selected to give a desired performance characteristic.

As will be apparent from FIGS. 1-3, numerous gas passageways are required to couple the inlet and exhaust parts of the turbochargers 11, 12, so that the arrangement is inevitably bulky and difficult to package within a congested engine compartment of a vehicle. On the exhaust (turbine) side there is significant loss of exhaust heat energy through conduction, convection and radiation because the exhaust gas flow has to pass through two turbines and the connecting passageways. This both raises the temperature of the engine compartment and cools the exhaust gas stream so that the time for light-off of the usual exhaust catalyst is increased; in turn this may reduce opportunities to regenerate a diesel particle filter (DPF) of a diesel engine. On the inlet (compressor) side there may be significant heating of the inlet charge by transmission of heat from the engine compartment, which reduces the effectiveness of charge compression notwithstanding that an intercooler may be provided in the inlet tract.

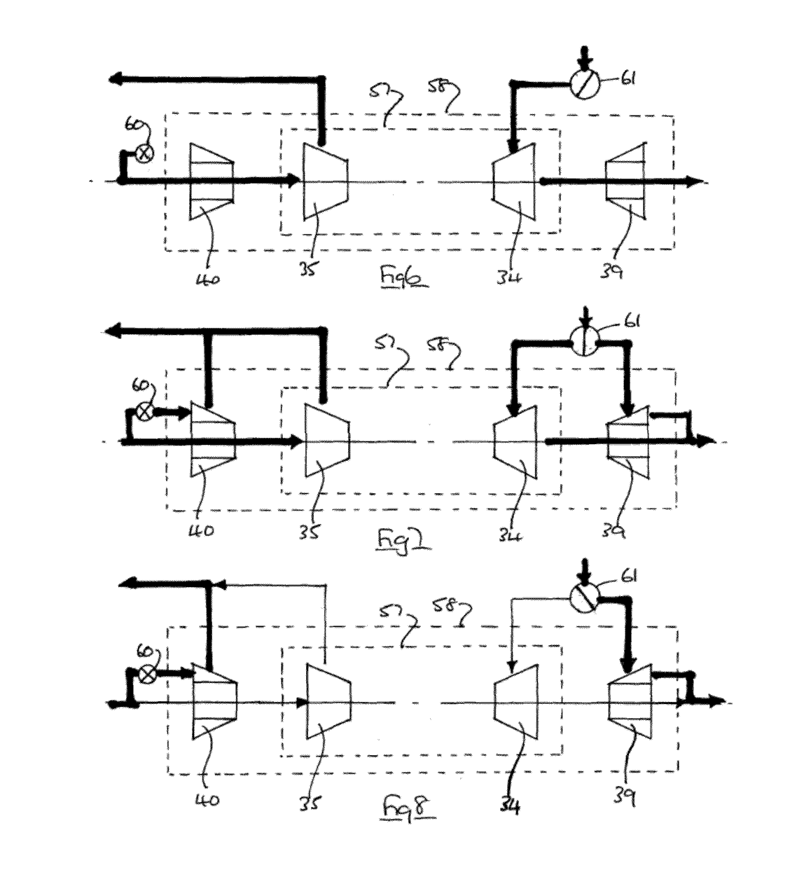

An embodiment of the invention is illustrated in FIG. 5.

A first two-stage turbocharger 31 comprises a housing 32 and defines a common axis of rotation 33 about which rotate turbine and compressor wheels of sequential stages. The first stage comprises an inboard turbine wheel 34 and an inboard compressor wheel 35 connected by a tubular shaft 36 for rotation in common. Illustrative support bearings 37 are provided. Journalled within the tubular shaft 36 is a second stage shaft 38 which couples a second stage turbine wheel 39 to a second stage compressor wheel 40. The second stage wheels 39, 40 are supported from the shaft 38 by radially extending vanes (not shown) which do not substantially obstruct through flow. The vanes can be described for example to allow some recovery of exhaust energy on the turbine stage and to generate favourable pre-whirl on the compressor side.

Fluid connections to the turbocharger comprise a gas inlet 41, an exhaust outlet 42, a charged air outlet 43 and an exhaust manifold coupling 44. Gas flow paths are illustrated by arrows. The gas passageways within the turbocharger are somewhat distorted in size for reasons of illustration, and in practice will be positioned and sized according to design requirements, and according to the position of connected apparatus and devices.

In the illustrated embodiment, the gas inlet 41 and the charge air outlet 43 are common to all compressor wheels, while the exhaust outlet 42 exhaust manifold coupling 44 are common to all turbine wheels. In alternative embodiments, a plurality of inlets or outlets may be provided for the compressor wheels or the turbine wheels such that, for example the two compressor wheels may be provided with individual inlets, or individual outlets. Similarly, the two turbine wheels may be provided with individual inlets, or individual outlets.

Also, for the purposes of illustration, control valves are omitted, but the function and location of such valves will be apparent from the following description, and by reference to the schematic drawing of FIGS. 1-3.

In use, exhaust gas entering via coupling 44 at low flow rate is directed through passage 51 over the small diameter turbine 34; a valve (not shown) may close the connected exhaust passage 52. The small diameter and mass of the first stage turbine 34 results in it spooling up at low flow rates so as to be effective at low engine speeds. The first stage compressor wheel 35 is accordingly driven by the shaft 36 to compress inlet gas which has passed through the centre of second stage compressor wheel 40. This compressed gas passes through delivery passage 53 to the inlet manifold. The connected inlet passage 54 is closed by a valve (not shown) to prevent backflow.

Turbocharging is thus effected by operation of the first stage only at low gas flow rates.

At higher gas flow rates, the first stage may approach a design limit, and accordingly the connected inlet and exhaust passages 52, 54 are progressively opened. Exhaust flow is sufficient to rotate the second stage turbine wheel 39, and thereby cause the second stage compressor wheel 40 to provide effective charge compression.

At the highest gas flow rates, the delivery passage 53 and the exhaust passage 51 may be closed or throttled to prevent over-speeding of the respective compressor and turbine wheels. The skilled man will provide an appropriate valve to ensure that pressure generated on the compressor side remains within safe limits, and may also provide a wastegate on the exhaust side. The first and second stages may operate sequentially at higher flow rates, or together, and some overlap may be desired.

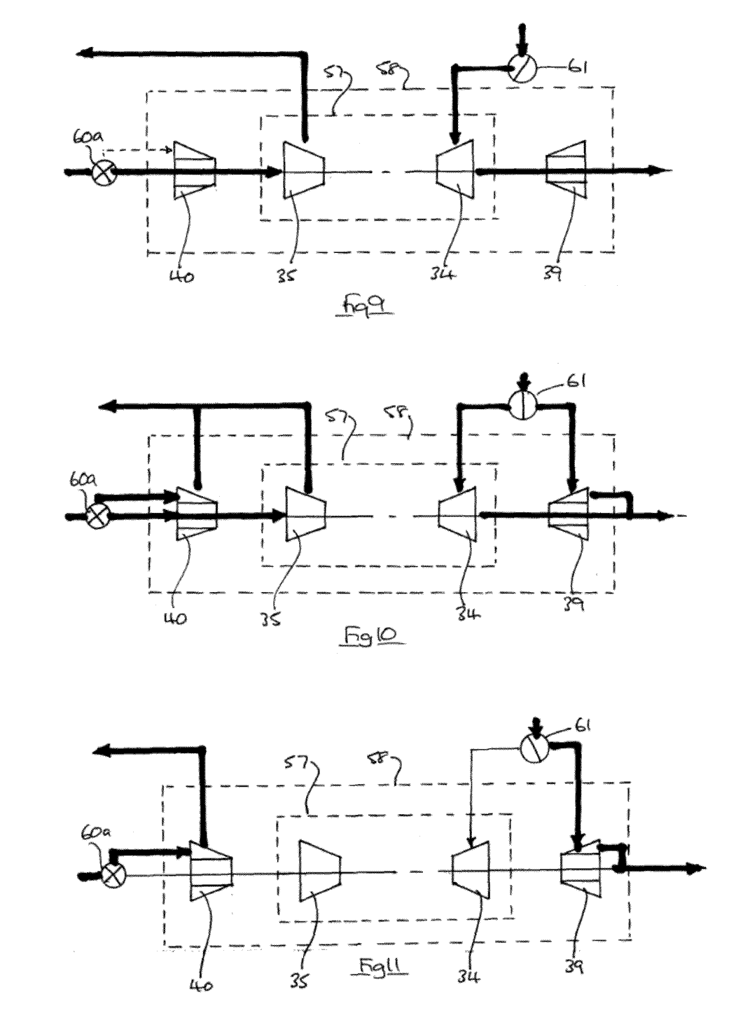

FIGS. 6-8 illustrate various flow path options. In FIG. 6, the first or primary stage 57 is in operation. A diverter valve 60 on the inlet side blocks flow to the second stage compressor wheel 40, whilst on the exhaust side a diverter valve 61 ensures that flow only passes over the primary turbine wheel 34. Thus only the primary compressor wheel 35 is effective.

In FIG. 7, both the primary 57 and the secondary stage 58 stage are operational, and inlet diverter valve 60 is allowing gas flow to the secondary compressor wheel 40 and primary compressor wheel 35. The diverter valve 61 adjusts exhaust flow to send a desired proportion to each turbine wheel, according to the desired turbocharger characteristic.

In FIG. 8 the diverter valve 61 sends a substantially part of the exhaust flow to the second stage turbine wheel 39, and by pressure balance to the first stage turbine wheel 34. As a consequence most of the compression is achieved by the second stage compressor wheel 40, the inlet diverter valve 60 allowing incoming air to flow therethrough.

Many other valve arrangements are possible in place of the described diverter valves to provide that gas flow passages are opened and closed in an appropriate manner. At higher gas flow rates the first stage turbine wheel 34 may be blocked entirely or may operate at speed so as to drive the first stage compressor wheel 35 effectively.

In all embodiments, a conventional bypass valve (wastegate) of conventional design could be added to the secondary turbine exhaust flow path.

The reduction in the number and extent of gas passageways results in less heat loss on the exhaust side, and thus a quicker light-off of the exhaust catalyst system is possible. On the inlet side, heating of the gas charge is reduced, so the intercooler size can be reduced or the performance of the engine improved if kept at the same size.

The invention also provides that rotating parts of the turbocharger do not stand still whilst the engine is running, which may better provide for good sealing of the turbocharger flow paths and lubrication of the bearing surfaces.

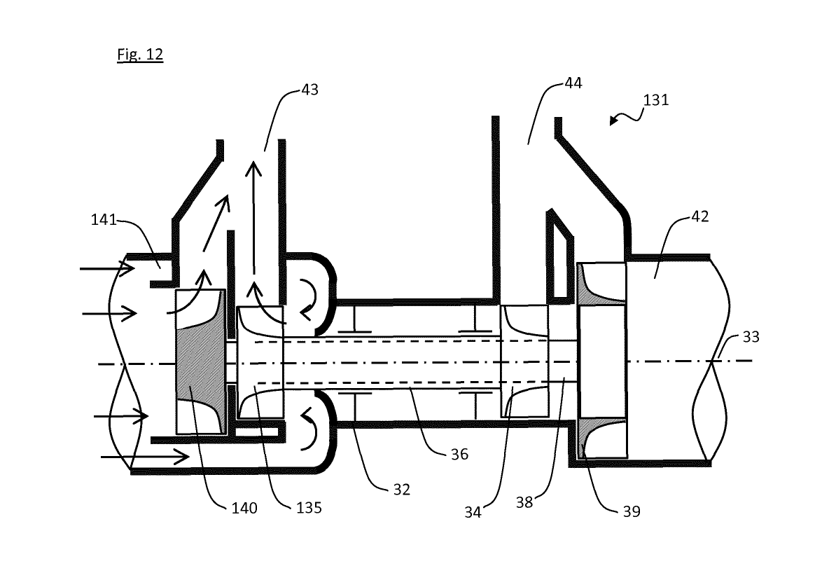

An alternative arrangement is shown in FIGS. 9-11.

FIG. 9 corresponds to FIG. 6, but a diverter valve 60a is placed in the air inlet duct rather than in an inlet tract of the second stage compressor wheel 40. The turbine side corresponds to FIG. 6, and components common to the embodiment of FIGS. 6-8 are given the same reference numerals.

In FIG. 9, the diverter valve 60a blocks flow to the second stage compressor wheel 40. The exhaust side diverter valve 61 sends all exhaust flow to the primary stage turbine 34. In this arrangement only the primary stage 57 is effective.

In FIG. 10 the diverter valve 60a is opened to allow flow to both primary and secondary stage compressor wheels (35, 40). Exhaust flow is directed by valve 61 to both primary and secondary stage turbine wheels (34, 39). The turbocharger operates with both stages, in parallel.

In FIG. 11 only the second stage is effective, and the diverter valve 60a blocks flow to the primary compressor wheel 35. Substantially all of the exhaust flow is directed to the second stage turbine wheel 39, with a small proportion going to the primary stage turbine wheel to ensure idling rotation thereof.

In a modification of the invention a stator is provided between the primary and secondary stages on the turbine side and/or on the compressor side. The stator would typically comprise a component mounted in the turbo pump housing and having a circular array of blades about the common axis of rotation so as to re-direct flow to the respective downstream compressor/turbine wheel.

FIG. 12 illustrates a second two stage turbocharger 131. The second two stage turbocharger 131 in FIG. 12 is similar to the first two stage turbocharger 31 in FIG. 5, and similar components are labelled as such. The two stage turbocharger 131 comprises a housing 32 and defines a common axis of rotation 33 about which rotate turbine and compressor wheels of sequential stages. The first stage comprises an inboard turbine wheel 34 and an inboard compressor wheel 135 connected by a tubular shaft 36 for rotation in common. Journalled within the tubular shaft 36 is a second stage shaft 38 which couples a second stage turbine wheel 39 to a second stage compressor wheel 140.

Each turbine wheel and each compressor wheel comprise a number of blades which are arranged substantially radially around the wheel's intended axis of rotation. These blades are supported by a back member. As such, each wheel is designed to have a front and a back, with gas traveling either into the blades at the front and away from the blades in a substantially radial direction, or traveling into the blades from a substantially radial direction and away from the blades at the front. The inboard compressor wheel 135 and the second stage compressor wheel 140 are arranged such that the back of the inboard compressor wheel 135 is facing the back of the second stage compressor wheel 140.

Fluid connections to the turbocharger comprise a gas inlet 141, an exhaust outlet 42, a charged air outlet 43 and an exhaust manifold coupling 44. The gas flow paths through the exhaust manifold coupling 44 and the charged air outlet 42 are as illustrated in FIG. 5. The gas flow paths through the gas inlet 141 and the charged air outlet 43 are illustrated by arrows, and the gas inlet 141 is shaped to provide gas flow to the front of both the second stage compressor wheel 140 and the inboard compressor wheel 135.

In use, exhaust gas enters via coupling 44 and leaves via coupling 42 as it does in the first two stage turbocharger 31. The inboard compressor wheel 135 and the second stage compressor wheel 140 can accordingly be driven by the shafts 36 and 38 to compress inlet gas,

1-23. (canceled)

24. A turbo pump comprising a plurality of compressor wheels and a plurality of turbine wheels rotatable in a housing about a common axis, one of the compressor or turbine wheels having an axial throughflow passage for supplying fluid to or receiving fluid from another of the compressor or turbine wheels.

25. A turbo pump according to claim 24, and defining an axial throughflow passage in one of the turbine wheels and in one of the compressor wheels.

26. A turbo pump according to claim 25, wherein each throughflow passage is co-axial about said common axis.

27. A turbo pump according claim 24, wherein the compressor wheels and the turbine wheels are coupled in pairs.

28. A turbo pump according to claim 25 wherein the plurality of compressor wheels are adjacent, and the plurality of turbine wheels are adjacent.

29. A turbo pump according to claim 28, wherein the axially outermost turbine wheel and compressor wheel define respective throughflow passages.

30. A turbo pump according to claim 29, wherein the axially outermost turbine wheel and compressor wheel have a larger diameter than any other of the turbine wheels and compressor wheels, respectively.

31. A turbo pump according to claim 27, wherein there are two compressor wheels and two turbine wheels.

32. A turbo pump according to claim 27, and further comprising a flow-aligning stator between adjacent compressor wheels, and a flow aligning stator between adjacent turbine wheels.

33. A turbo pump according to claim 27, wherein one turbine wheel is connected to one compressor wheel by a sleeve, and another turbine wheel is connected to another compressor wheel by a spindle journalled in said sleeve.

34. A turbo pump according to claim 33, wherein said sleeve is journalled in said housing.

35. A turbo pump according to claim 24, wherein one of the compressor and turbine wheels comprises radially extending vanes in said passage.

36. A turbo pump according to claim 35, wherein said vanes are arcuate.

37. A turbo pump according to claim 35, wherein said vanes are straight.

38. A turbo pump according to claim 24, wherein said housing has a single exhaust outlet downstream of the turbine wheels.

39. A turbo pump according to claim 24, wherein said housing has a single inlet upstream of the turbine wheels.

40. A turbo pump according to claim 24, and further comprising a stator between adjacent turbine wheels.

41. A turbo pump according to claim 24, and further comprising a stator between adjacent compressor wheels.

42. A turbo pump according to claim 24, and comprising an exhaust turbocharger of an internal combustion engine.

43. A turbo pump according to claim 24, in which one of the compressor wheels is mounted back to back with another of the compressor wheels.

44. A turbo pump according to claim 24, in which one of the turbine wheels is mounted back to back with another of the turbine wheels.

45. A turbo pump according to claim 24, wherein said housing has at least one gas or exhaust inlet or outlet which is connected to at least one of another charge air device, or an intercooler device, or a manifold device.

46. An engine comprising a turbo pump, including a plurality of compressor wheels and a plurality of turbine wheels rotatable in a housing about a common axis, one of the compressor or turbine wheels having an axial throughflow passage for supplying fluid to or receiving fluid from another of the compressor or turbine wheels.

47. A vehicle comprising a turbo pump, including a plurality of compressor wheels and a plurality of turbine wheels rotatable in a housing about a common axis, one of the compressor or turbine wheels having an axial throughflow passage for supplying fluid to or receiving fluid from another of the compressor or turbine wheels.
